(19) United States
(12) Patent Application Publication
(10) Pub. No.: US 2026/0148749 A1
(43) Pub. Date: May 28, 2026

(54) Asymmetric Side Gap Writer Fabricated By Ion-Beam Etching (IBE) / Ion-Beam Deposition (IBD) Process For Aerial Density Capability (ADC) Improvement

(71) Applicant: Headway Technologies, Inc., Milpitas, CA (US)

(72) Inventors: Haowen Ren, Fremont, CA (US); Yuhui Tang, Milpitas, CA (US); Weihao Xu, San Jose, CA (US); Yue Liu, Fremont, CA (US); Yu-Hsia Chen, Los Altos, CA (US); Weisheng Hu, Fremont, CA (US); Shengyuan Wang, San Jose, CA (US)

(21) Appl. No.: 18/962,308

(22) Filed: Nov. 27, 2024

(51) Int. Cl. G11B 5/39; G11B 5/60

(52) U.S. Cl. CPC G11B 5/3912; G11B 5/6082

(57) ABSTRACT

The present embodiments relate to a write head with an asymmetrical side gap (SG) design. In the asymmetrical design, the main pole can be disposed offset to a central axis of the write head such that the main pole is closer to a first side shield (SS) portion than a second SS portion. The asymmetrical design can be achieved using an ion-beam etching (IBE) or ion-beam deposition (IBD) process. The asymmetrical design can provide a narrower side gap width while mitigating any writability limitations or constraints caused by scaling down the SG.

### TECHNICAL FIELD

Embodiments of the invention relate to the field of electro-mechanical data storage devices. More particularly, embodiments of the invention relate to a write head with an asymmetric side gap design.

### BACKGROUND

A magnetic recording medium (e.g., a magnetic disk) can store magnetic bits representing digital data. A magneto-resistive writer can be part of a hard disk drive (HDD) to write digital data to the magnetic recording medium.

As an overall amount of digital data being stored on HDD devices increases, there is an increasing demand for increased data capacity of HDD devices. One technique to increase data capacity for an HDD can include heat-assisted magnetic recording (HAMR) or microwave-assisted magnetic recording (MAMR). HAMR and MAMR techniques increase the density of HDDs by manipulating a portion of the magnetic recording medium, which can enhance write performance of the write head to the magnetic recording medium.

### SUMMARY

The present embodiments relate to a write head with an asymmetrical side gap (SG) design. In the asymmetrical design, the main pole can be disposed offset to a central axis of the write head such that the main pole is closer to a first side shield (SS) portion than a second SS portion. The asymmetrical design can be achieved using an ion-beam etching (IBE) or ion-beam deposition (IBD) process. The asymmetrical design can provide a narrower side gap width while mitigating any writability limitations or constraints caused by scaling down the SG.

In a first example embodiment, a write head is provided. The write head can include a magnetic main pole (MP) and a magnetic trailing shield comprising at least a hot seed (HS) layer disposed adjacent to the MP. The write head can also include a first side shield (SS) portion disposed on a first side of a central axis and a second SS portion disposed on a second side of the central axis. A center of the MP can be disposed offset from the central axis such that a distance between a center of the MP and the first SS portion is less than a distance between the center of the MP and the second SS portion.

In some instances, the HS layer is configured to collect a magnetic flux from the MP and increase a down-track gradient, and wherein the first SS portion and the second SS portion are configured to confine the magnetic flux in a cross-track direction to increase a cross-track gradient.

In some instances, the write head can also include a first dielectric layer disposed adjacent to the first SS portion, a second dielectric layer disposed adjacent to the second SS portion, a first metallic layer disposed between the MP and the first dielectric layer, and a second metallic layer disposed between the MP and the second dielectric layer.

In some instances, the second dielectric layer is milled to a thickness less than that of the first dielectric layer using an ion-beam etching (IBE) process by applying directional etching to the first dielectric layer and/or the second dielectric layer.

In some instances, the directional etching is at an angle ranging from 0-20 degrees parallel to an air-bearing surface (ABS) direction, and at tilt angles ranging between 45-75 degrees perpendicular to the write head.

In some instances, a thickness of the first metallic layer is greater than that of the second metallic layer based on an ion-beam disposition (IBD) process providing a directional deposition on the first metallic layer and/or the second metallic layer.

In some instances, the directional deposition is at an angle ranging from 0-20 degrees parallel to an air-bearing surface (ABS) direction, and at tilt angles ranging between 10-30 degrees perpendicular to the write head.

In some instances, the first dielectric layer and/or the second dielectric layer comprise an insulating material including aluminum oxide (AlOₓ), a silicone oxide (SiOₓ), an aluminum nitride (AlNₓ).

In some instances, the first metallic layer and/or the second metallic layer comprise a Ruthenium (Ru) material or a Nickel/Chromium (Ni/Cr) multilayer.

In some instances, a width of a side gap (SG) between each of the first SS portion and the second SS portion ranges between 5-100 nanometers (nm) on each side of the central axis.

In some instances, a difference between the distance between the center of the MP and the first SS portion and the distance between the center of the MP and the second SS portion ranges between 1 and 50 nm.

In another example embodiment, a method is provided. The method can include providing a write head structure with at least a first side shield (SS) portion disposed on a first side of a central axis and a second SS portion disposed on a second side of the central axis. The method can also include disposing a first dielectric layer adjacent to the first SS portion. The method can also include disposing a second dielectric layer adjacent to the second SS portion. The method can also include disposing a first metallic layer adjacent to the first dielectric layer. The method can also include disposing a second metallic layer adjacent to the second dielectric layer.

The method can also include performing an ion-beam etching (IBE) process by applying directional etching to the first dielectric layer and/or the second dielectric layer to cause a different thickness between the first dielectric layer and the second dielectric layer, or performing an ion-beam disposition (IBD) process providing a directional deposition on the first metallic layer and/or the second metallic layer to cause a different thickness between the first metallic layer and the second metallic layer. The method can also include disposing a main pole (MP) between the first SS portion and the second SS portion. A center of the MP can be disposed offset from the central axis such that a distance between a center of the MP and the first SS portion is less than a distance between the center of the MP and the second SS portion.

In some instances, the directional etching is at an angle ranging from 0-20 degrees parallel to an air-bearing surface (ABS) direction, and at tilt angles ranging between 45-75 degrees perpendicular to the write head.

In some instances, the directional deposition is at an angle ranging from 0-20 degrees parallel to an air-bearing surface (ABS) direction, and at tilt angles ranging between 10-30 degrees perpendicular to the write head.

In some instances, the first dielectric layer and/or the second dielectric layer comprise an insulating material including aluminum oxide (AlOₓ), a silicone oxide (SiOₓ), an aluminum nitride (AlNₓ).

In some instances, the first metallic layer and/or the second metallic layer comprise a Ruthenium (Ru) material or a Nickel/Chromium (Ni/Cr) multilayer.

In another example embodiment, a device is provided. The device can include a magnetic main pole (MP), a first metallic layer disposed adjacent to a first side of the MP, and a second metallic layer disposed adjacent to a second side of the MP. The device can also include a first dielectric layer disposed adjacent to the first metallic layer and a second dielectric layer disposed adjacent to the second metallic layer.

The device can also include a first side shield (SS) portion disposed on a first side of a central axis and adjacent to the first dielectric layer. The device can also include a second SS portion disposed on a second side of the central axis. A center of the MP can be disposed offset from the central axis such that a distance between a center of the MP and the first SS portion is less than a distance between the center of the MP and the second SS portion.

In some instances, the second dielectric layer is milled to a thickness less than that of the first dielectric layer using an ion-beam etching (IBE) process by applying directional etching to the first dielectric layer and/or the second dielectric layer, wherein the directional etching is at an angle ranging from 0-20 degrees parallel to an air-bearing surface (ABS) direction, and at tilt angles ranging between 45-75 degrees perpendicular to the device.

In some instances, a thickness of the first metallic layer is greater than that of the second metallic layer based on an ion-beam disposition (IBD) process providing a directional deposition on the first metallic layer and/or the second metallic layer, wherein the directional deposition is at an angle ranging from 0-20 degrees parallel to an air-bearing surface (ABS) direction, and at tilt angles ranging between 10-30 degrees perpendicular to the device.

In some instances, the first dielectric layer and/or the second dielectric layer comprise an insulating material including aluminum oxide (AlOₓ), a silicone oxide (SiOₓ), an aluminum nitride (AlNₓ), and wherein the first metallic layer and/or the second metallic layer comprise a Ruthenium (Ru) material or a Nickel/Chromium (Ni/Cr) multilayer.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a perspective view of a head arm assembly, according to prior art embodiments.

FIG. 2 is side view of a head stack assembly, according to prior art embodiments.

FIG. 3 is a plan view of a magnetic recording apparatus, according to prior art embodiments.

FIG. 4 illustrates an example symmetric write head according to an embodiment.

FIG. 5 illustrates an example graphical representation of a magnetic field (Hc) line for a symmetric write head according to an embodiment.

FIG. 6 illustrates an example asymmetric write head according to an embodiment.

FIG. 7 illustrates an example graphical representation of a magnetic field (Hc) line for an asymmetric write head according to an embodiment.

FIG. 8A is an example top view for generating an asymmetric MP write head according to an embodiment.

FIG. 8B is an example air-bearing surface (ABS) view of an asymmetric write head formed via an IBE approach according to an embodiment.

FIG. 8C is an example air-bearing surface (ABS) view of an asymmetric write head formed via an IBD approach according to an embodiment.

FIG. 9 illustrates a graphical representation of a magnetic field (Hy) as a function of Ew according to an embodiment.

FIG. 10 illustrates a graphical illustration of a DT gradient/CT gradient nSG/CT gradient wSG as a function of EW according to an embodiment.

FIG. 11 is an example graphical representation illustrating an example EBi & Ebo relative to regions for each of a number of example write head models according to an embodiment.

FIG. 12 is an example graphical illustration of a max TAA SMA for each of a number of regions according to an embodiment.

FIG. 13 illustrates an example graphical representation of a maximum TAA average relative to an EW for write head designs according to an embodiment.

### DETAILED DESCRIPTION

A disk drive can include a write head to interact with a magnetic recording medium to read and write digital data to the magnetic recording medium. As the amount of digital data is required to be stored increases and with an increase in data aerial density of hard disk drive (HDD) writing, both the write head and digital data written to the magnetic recording medium can generally be made smaller.

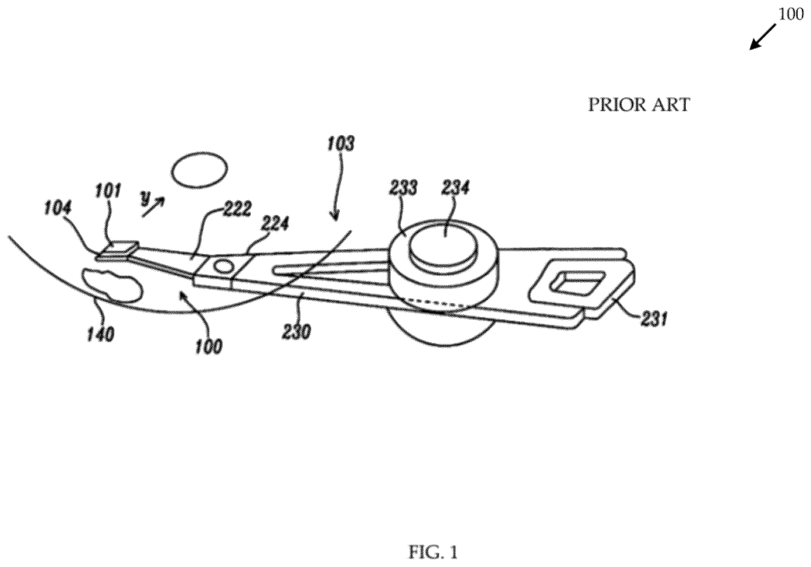

FIG. 1 is a perspective view of a prior art head arm assembly 100, according to some embodiments of the present disclosure. Referring to FIG. 1, a head arm assembly (or Head Gimbal Assembly (HGA)) 100 includes a magnetic recording head 101 comprised of a slider and a PMR writer structure formed thereon, and a suspension that elastically supports the magnetic recording head. The suspension has a plate spring-like load beam 222 formed with stainless steel, a flexure 104 provided at one end portion of the load beam, and a base plate 224 provided at the other end portion of the load beam. The slider portion of the magnetic recording head is joined to the flexure, which gives an appropriate degree of freedom to the magnetic recording head. A gimbal part (not shown) for maintaining a posture of the magnetic recording head at a steady level is provided in a portion of the flexure to which the slider is mounted.

HGA 100 is mounted on an arm 230 formed in the head arm assembly 103. The arm moves the magnetic recording head 101 in the cross-track direction y of the magnetic recording medium 140. One end of the arm is mounted on base plate 224. A coil 231 that is a portion of a voice coil motor is mounted on the other end of the arm. A bearing part 233 is provided in the intermediate portion of arm 230. The arm is rotatably supported using a shaft 234 mounted to the bearing part 233. The arm 230 and the voice coil motor that drives the arm configure an actuator.

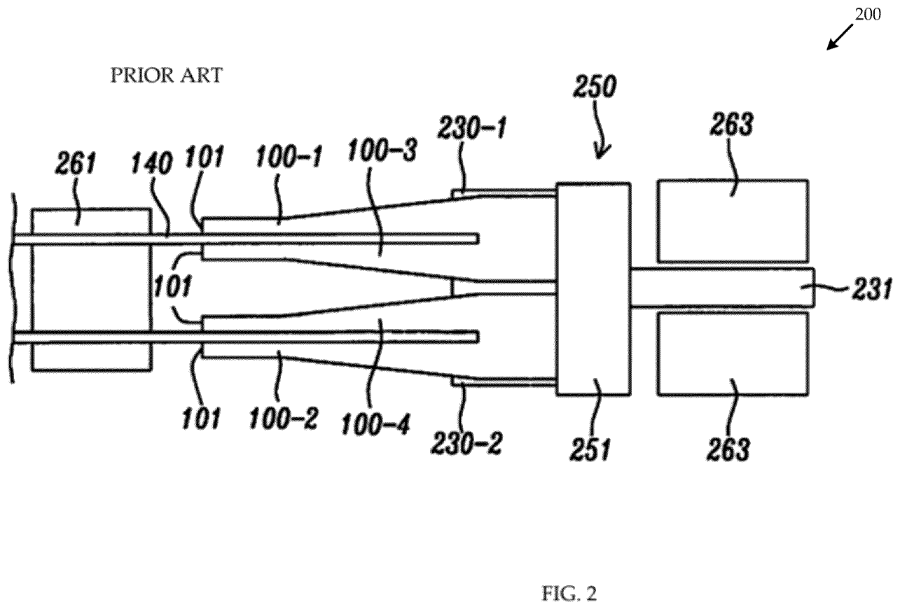

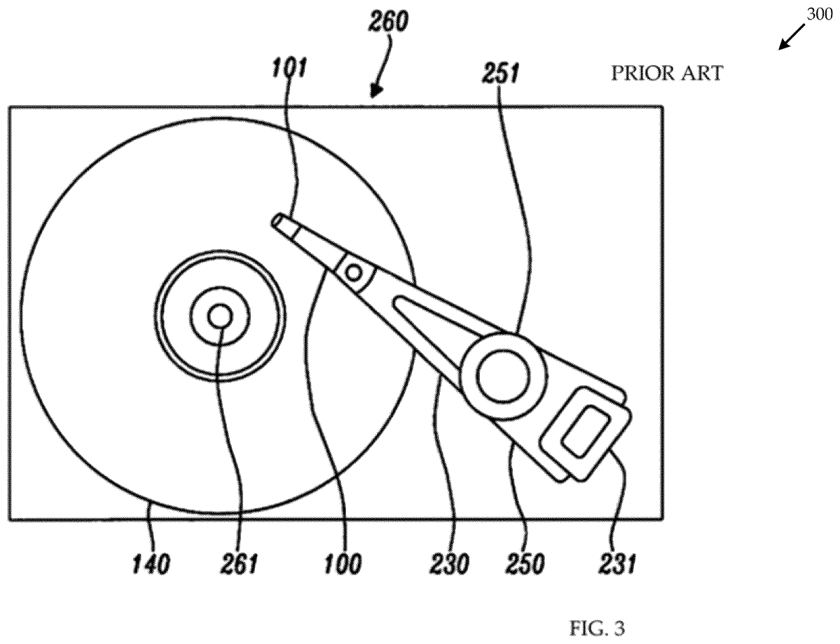

Next, a side view 200 of a head stack assembly (FIG. 2) and a plan view 300 of a magnetic recording apparatus (FIG. 3) wherein the magnetic recording head 101 is incorporated are depicted. The head stack assembly 250 is a member to which a plurality of HGAs (HGA 100-1 and second HGA 100-2 are at outer positions while HGA 100-3 and HGA 100-4 are at inner positions) is mounted to arms 230-1, 230-2, respectively, on carriage 251. A HGA is mounted on each arm at intervals so as to be aligned in the perpendicular direction (orthogonal to magnetic medium 140). The coil portion (231 in FIG. 1) of the voice coil motor is mounted at the opposite side of each arm in carriage 251. The voice coil motor has a permanent magnet 263 arranged at an opposite position across the coil 231.

With reference to FIG. 3, the head stack assembly 250 is incorporated in a magnetic recording apparatus 260. The magnetic recording apparatus has a plurality of magnetic media 140 mounted to spindle motor 261. For every magnetic recording medium, there are two magnetic recording heads arranged opposite one another across the magnetic recording medium. The head stack assembly and actuator except for the magnetic recording heads 101 correspond to a positioning device, and support the magnetic recording heads, and position the magnetic recording heads relative to the magnetic recording medium. The magnetic recording heads are moved in a cross-track of the magnetic recording medium by the actuator. The magnetic recording head records information into the magnetic recording media with a PMR writer element (not shown) and reproduces the information recorded in the magnetic recording media by a magneto-resistive (MR) sensor element (not shown).

To achieve higher area density capability (ADC), many write heads were designed to record longitudinal magnetic recording (LMR) and then migrated to perpendicular magnetic recording (PMR) writers. Further, the introduction of trailing shield (TS), leading shield (LS), and side shield (SS) provided improved down-track and cross-track gradients, which can be used to achieve higher track per inch (TPI) and bit per inch (BPI).

As TPI increases, the size of MP may need to be further shrunk down, as well as the media grain size. However, due to the shrinkage of the MP size and smaller writer gap (WG) and side gap (SG), the writability of the write head becomes too weak so that the writer is no longer capable of writing the media with certain thermal stability without losing signal-to-noise ratio (SNR). This is so called the trilemma in recording physics that limits the further improvement of PMR writer head.

One potential path to further improve aerial data capability (ADC) is by scaling down the writer structure. Due to the limitation of the pre-amplifier, the data rate may have almost reached its limitation, which further restricted BPI improvement. Rather, effort can be focused on TPI improvement. The side shield (SS) can be one of the more critical components that impact the final TPI performance of the write head, as the SS can largely impact how much magnetic flux goes into the side tracks and the confinement of the side track flux.

To improve the SS confinement and gain better cross-track gradient, side gap (SG) shrinkage can be a first order factor. However, due to the trilemma in recording physics, further scaling down the SG can result in writability issues of the write head due to more flux leakage in the SS. Further, a higher magnetic moment in the SS can further lower the writability of the write head.

The present embodiments relate to systems and methods for manufacturing an asymmetric side gap (asySG) design write head that can provide a narrower side gap without writability issues resulting from scaling down the SG generally.

In such designs, two separate approaches (ion-beam etching (IBE) or ion-beam deposition (IBD)) can achieve the asySG structure without additional mask for IBE or IBD. The designs can also maintain a similar erase width (EW)/full width at half maximum (FWHM) without losing maximum signal track strength, while also benefitting a conventional magnetic recording (CMR) writing mode. The designs can also provide erase band width (EB) advantages on the narrow SG side. Further, a shingled magnetic recording (SMR) ADC gain can be achieved if the narrow SG side is assigned to the outside diameter (OD) writing region. Such designs can also be compatible with various write head (e.g., conventional tunable pole protrusion (cTPP), tunable pole protrusion (TPP), giant magnetoresistance (GMAC/GMR3B) designs.

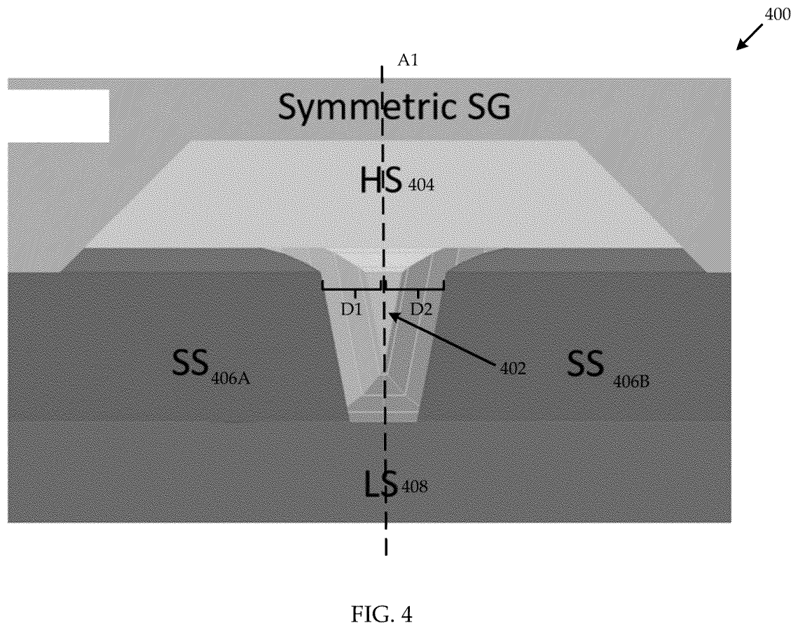

FIG. 4 illustrates an example symmetric write head 400. As shown in FIG. 4, the symmetric write head 400 can include a MP 402 disposed adjacent to a hot seed (HS) 404, SS portions (e.g., first or “left” SS 406A, second or “right” SS 406B), and a leading shield (LS) 408.

A center axis Al can split a central portion of the write head 400. In the example in FIG. 4, the main pole 402 can be disposed directly through axis Al such that a distance between a center of the main pole 402 and the first SS 406A (shown by D1) is about the same or the same as the distance between the center of the main pole 402 and the second SS 406B (shown by D2).

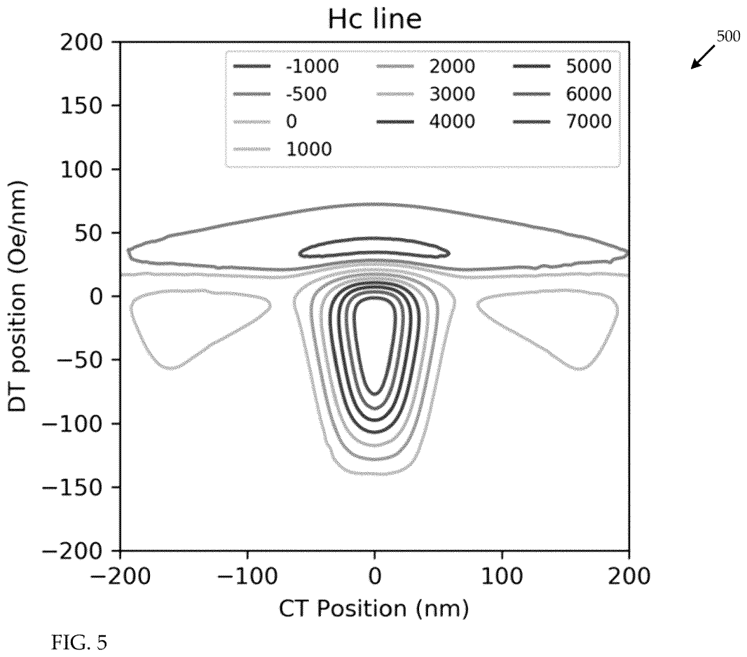

FIG. 5 illustrates an example graphical representation 500 of a magnetic field (Hc) line for a symmetric write head. The representation in FIG. 5 illustrates an example symmetric magnetic field profile generated from the head cross-track (CT) position and the down-track (DT) of the write head 400 in FIG. 4.

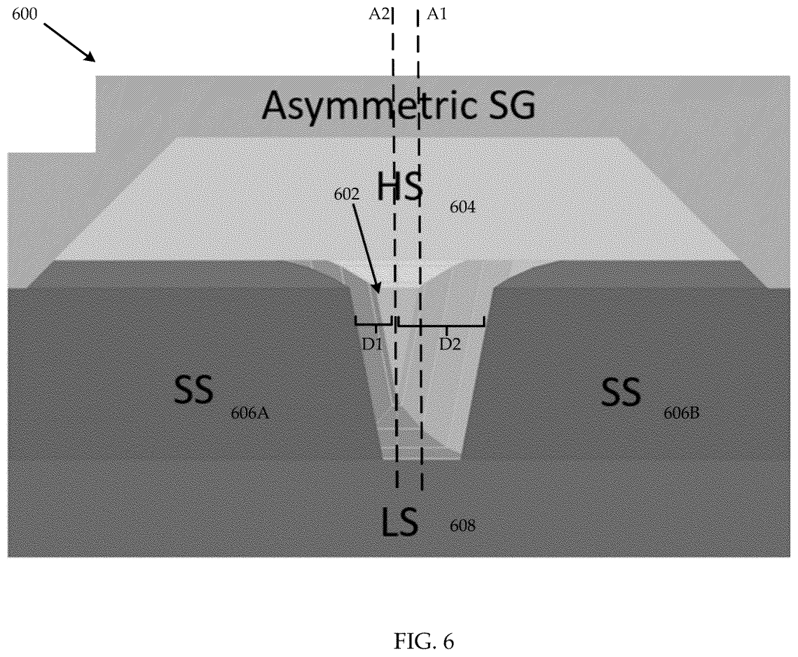

In comparison with a symmetric SG design, a critical feature of the asymmetric SG design can include the shifting of MP that can provide a different SG distance between left SG and right SG. FIG. 6 illustrates an example asymmetric write head 600. The write head 600 as shown in FIG. 6 can include the main pole 602 shifted relative to the first SS 606A and second SS 606B, with the HS 604 and LS 608 disposed adjacent to the main pole 602.

In an asymmetric design, such as the design in FIG. 6, the main pole (MP) 602 can be shifted (e.g., shifted left) such that the MP 602 is no longer disposed at axis A1 but rather at axis A2. This shifting can lead to a difference in gap distances between the MP and each SS portion. For example, a distance from a center of the MP 602 to the first (or “left”) SS 606A defined as D1 can be less than a distance D2 from a center of the MP 602 to the second (or “right”) SS 606B. The difference between D1 and D2 can illustrate a gap distance difference between the shifted MP 602 and each SS portion 606A, 606B.

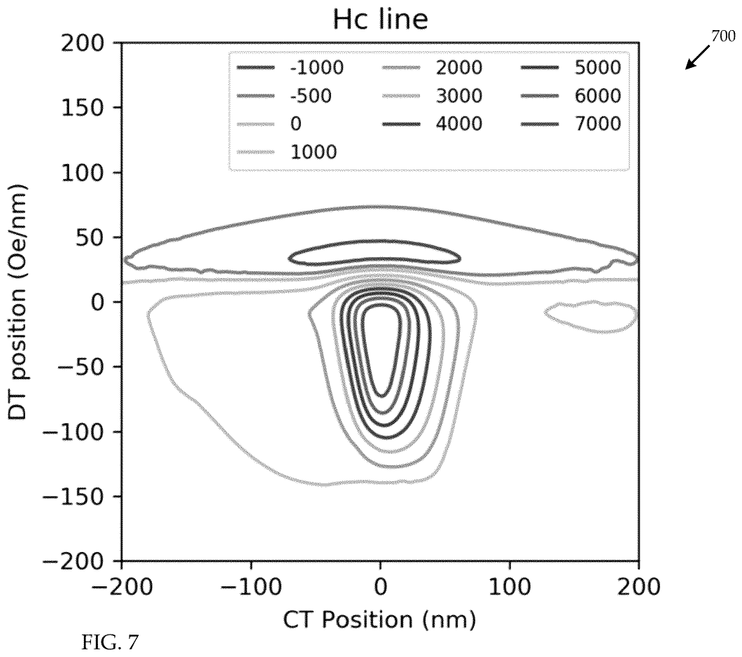

FIG. 7 illustrates an example graphical representation 700 of a magnetic field (Hc) line for an asymmetric write head. The representation in FIG. 7 illustrates an example symmetric magnetic field profile generated from the head cross-track (CT) position and the down-track (DT) of the asymmetric write head 600 in FIG. 6. FIG. 7 can illustrate the field profile as a result of the asymmetric SG, which can make the field tilted toward the narrower SG side.

Different fabrication processes can be implemented to manufacture a write head with an asymmetric SG design. A first example design can include an ion beam etching (IBE) approach. After formation of the side shield, IBE can be applied to mill a portion of the field dielectric material.

Applying the IBE can include selecting different IBE angles ranging from 0 to 20 degrees parallel to the ABS direction, as well as tilt angles between 45 and 75 degrees perpendicular to the substrate. Further, the etch time can be adjusting during the IBE process, and different amounts of insulator material can be formed on the left and right sides of the side shield. Once the insulator is formed, a Ruthenium (Ru) SG deposition and MP plating processes were followed to create the MP structure.

A second approach can include using ion beam deposition (IBD). After the side shield formation and symmetrical insulator formation through the IBE process, a metal layer can be deposited. This metal layer could include a material such as Tantalum (Ta), Ruthenium (Ru), or another suitable metal material.

The IBD process can include adjusting the deposition angle between 0 and 20 degrees parallel to the ABS direction or the tilt angle between 10 and 30 degrees perpendicular to the substrate. Further, the deposition time can be adjusted, and different amounts of metal can be deposited on the left and right sides of the side shield. Once the metal deposition was completed, the MP plating process can be carried out to form the MP structure.

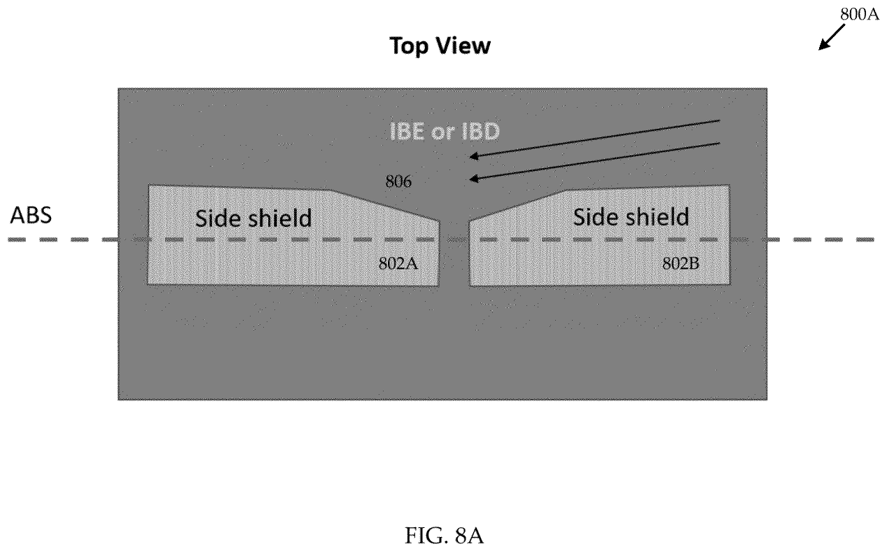

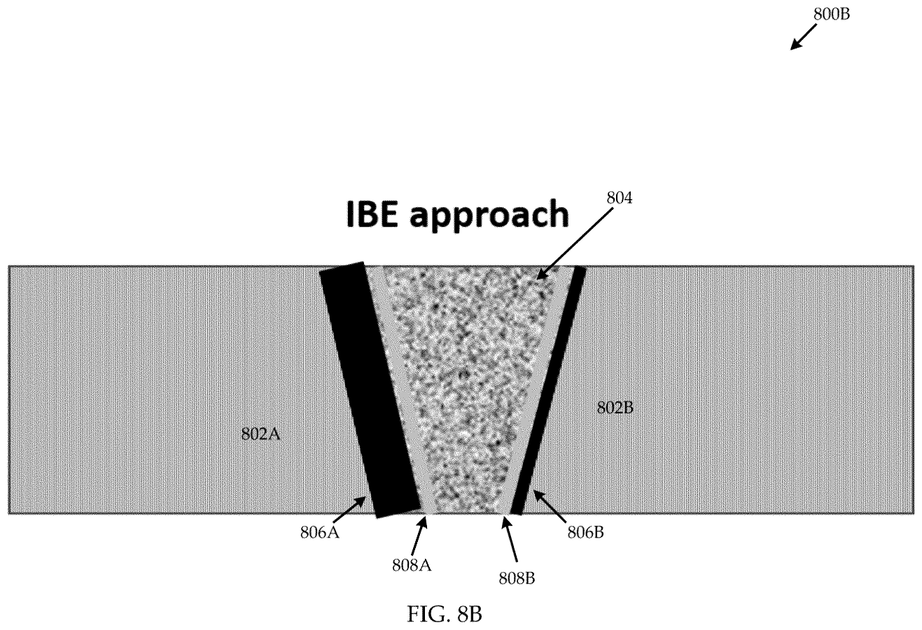

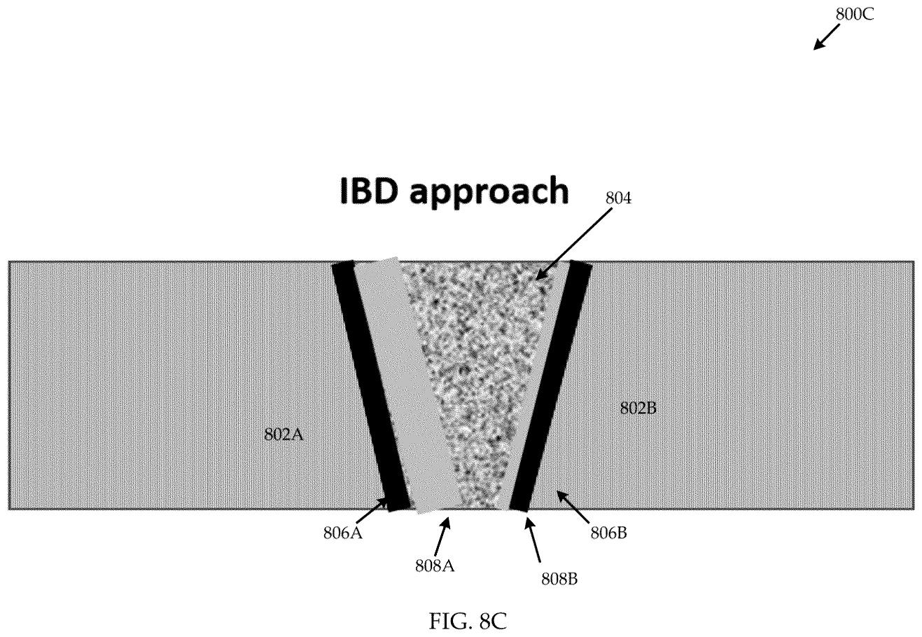

FIG. 8A is an example top view 800A for generating an asymmetric MP write head. As shown in FIG. 8A, the side shield portions 802A-B can be disposed adjacent to a dielectric material 806. An IBE or IBD process as described herein can mill part of the dielectric material 806 in a direction as shown by arrows.

FIG. 8B is an example air-bearing surface (ABS) view of an asymmetric write head formed via an IBE approach 800B. As shown in FIG. 8B, portions of the dielectric material 806A, 806B can be milled differently to provide the asymmetric MP material. For instance, first dielectric material 806A can be milled less than second dielectric material 806B. Further, a metallic material 808A, 808B can be disposed over the dielectric material 806A, 806B, and the MP material 804 can be formed over the metallic materials 808A, 808B.

FIG. 8C is an example air-bearing surface (ABS) view of an asymmetric write head formed via an IBD approach 800C. As shown in FIG. 8C, portions of the dielectric material 806A, 806B can be disposed over respective SS portions 802A, 802B. Further, metallic material portions 808A, 808B can be disposed over the dielectric material 806A, 806B via a IBD process. The metallic materials 808A, 808B can be deposited differently such that more material is disposed at a first metallic material portion 808A than a second metallic material portion 808B. A thickness of the first metallic material portion 808A can be greater than that of the second metallic material portion 808B. The MP material 804 can be disposed over metallic material portions 808A, 808B using any of a variety of processes.

In some cases, conventional magnetic recording (CMR) writing can have a fixed track pitch for all regions, as the signal tracks may not be overlapping with each other. In some cases, shingled magnetic recording (SMR) writing mode can have a limitation of writability in CMR.

Some factors that can be important parameters for CMR and SMR writing modes. In CMR mode, the gating factor of achieving higher ADC usually comes from the skew angle. At inner disk/outer disk region (ID/OD), the skew angle can cause erase width (EW) enlargement, while the smaller EW determine the higher TPI. However, smaller EW can cause weaker writability.

This can be particularly prevalent once the MP width is scaled down below 40 nanometers (nm). Hence, in CMR mode, to further scale down the EW without losing signal strength and writability can be a challenge. In SMR mode, the erase band (EB) can be a deterministic factor to gain SMR ADC, since the smaller the EB, the stronger the signal after singled writing.

To evaluate the asymmetric SG design, multilayer media modeling can be performed.

For example, models can be based off of two symmetric SG designs (e.g., 40/40 nm and 50/50 nm SG), and two models based off of asymmetric SG designs (e.g., 20/60 nm and 40/60 nm). Wider PWA with narrower SG can also be included (PWA45/SG20). In FIG. 3(a), we can clearly see that compared to conventional approach for further performance improvement (wider PWA with narrower SG), asySG design shows no loss on writability. Meanwhile, as shown in FIG. 3(b), compared to conventional design, asySG design shows large cross-track (CT) gradient gain on nSG side, which is favorable for SMR writing.

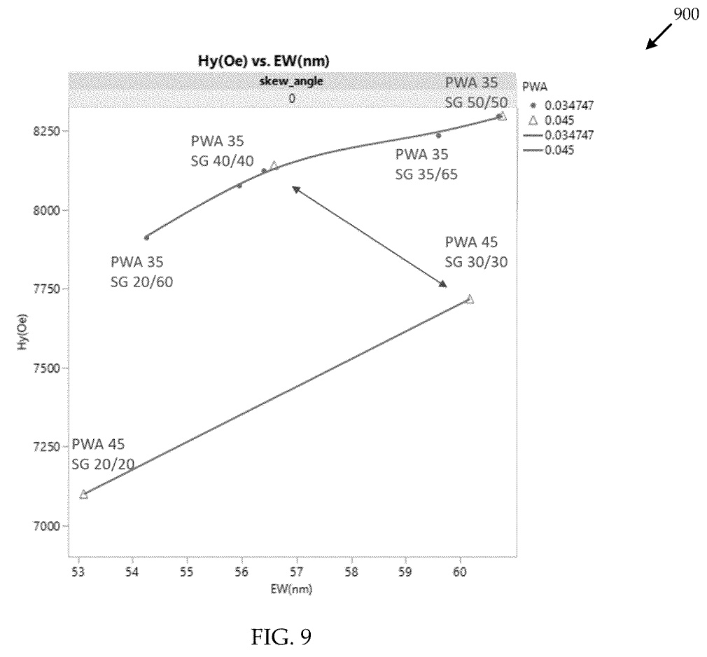

FIG. 9 illustrates a graphical representation 900 of a magnetic field (Hy) as a function of Ew. The graphical representation 900 can illustrate the Hy as a function of Ew for each of a number of models as described above. The Hy can be measured in Oersteds, and the Ew can be measured in nanometers (nm).

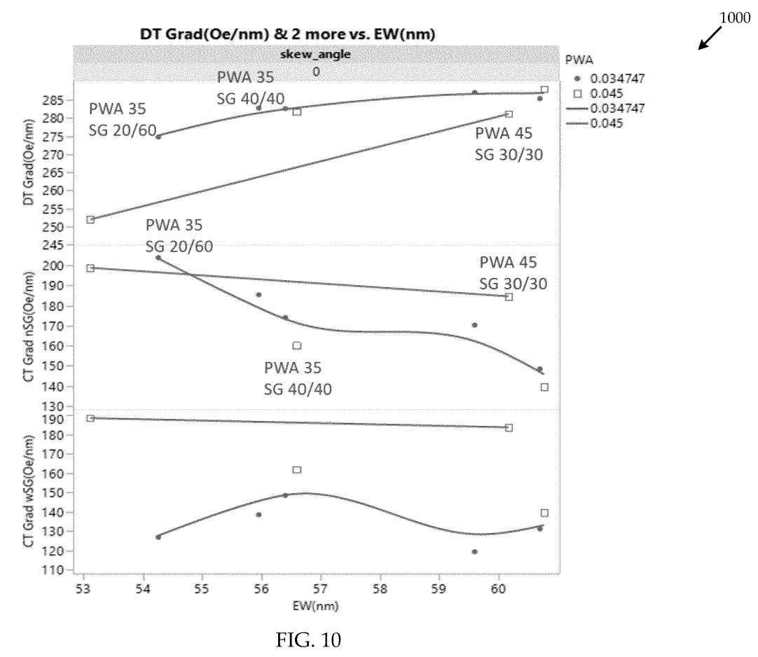

FIG. 10 illustrates a graphical illustration 1000 of a DT gradient/CT gradient nSG/CT gradient wSG as a function of EW. The graphical representation 1000 can illustrate each of a DT gradient (in Oe/nm), a CT gradient nSG (in Oe/nm), and a CT gradient wSG (in Oe/nm) as a function of Ew (in nm) for each of a number of models as described above.

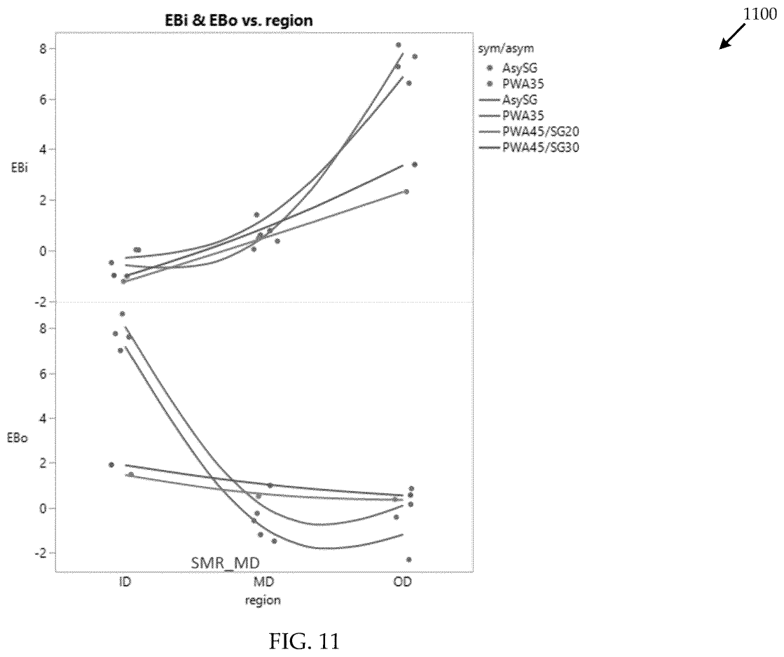

Further, to evaluate the EB and maximum TAA of the asySG design, the media modeling can mimic any of a variety of testing methodologies. A smaller EB benefit can be observed in asySG design at the narrower SG side, while a slightly increase in EB at the wider SG side can be provided, as shown in FIG. 11, for example. FIG. 11 is an example graphical representation 1100 illustrating an example EBi & Ebo relative to regions for each of a number of example write head models. For instance, in FIG. 11, an inside EB (EBi) and an outside EB (EBo) can be depicted in each of an inside (ID), middle (MD) and outer (OD) diameter region for a number of asymmetric write head designs.

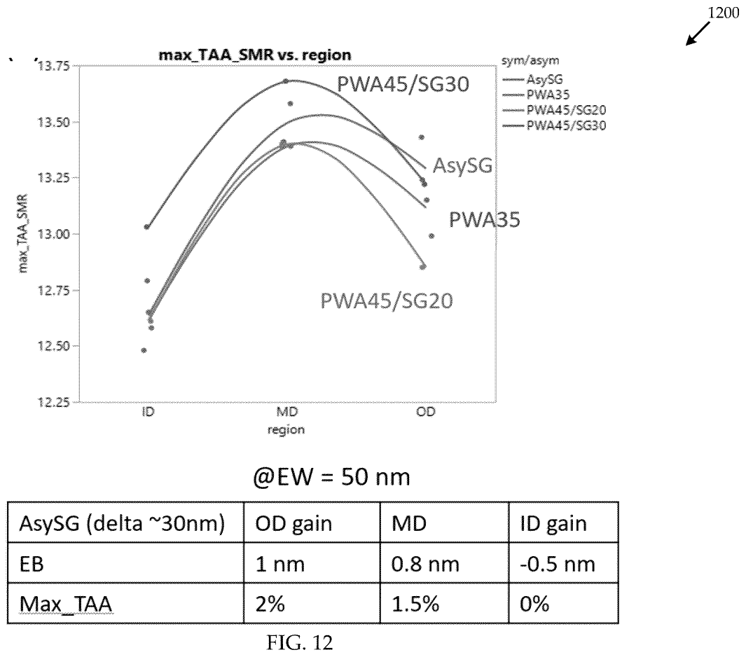

Further, a maximum TAA gain at nSG side can be observed. For the SMR writing, the head will shingle write at the smallest EB side to gain the best ADC. FIG. 12 is an example graphical illustration 1200 of a max TAA SMA for each of a number of regions. In FIG. 12, the representation 1200 can depict a max TAA for SMR recording at the ID, MD, and OD regions.

FIG. 12 also depicts a table of the EB and maximum TAA gain of asySG design compared to symmetric design at nominal total SG. As shown in the table in FIG. 12, if the best EB side of asymmetric SG design for SMR writing is selected and assigned to the OD region, since it can attribute the largest writing area of the whole disk, the EB can be shrunk by at least 1 nm at OD, 0.8 nm at MD, while a- 0.5nm penalty in ID, with better or equal maximum TAA, and obtain the highest ADC again for SMR.

For CMR writing, shrinking down the EW can be an important feature for an improved write head. By modeling the single-track writing, the EW and maximum TAA signal can be determined by reading the written track.

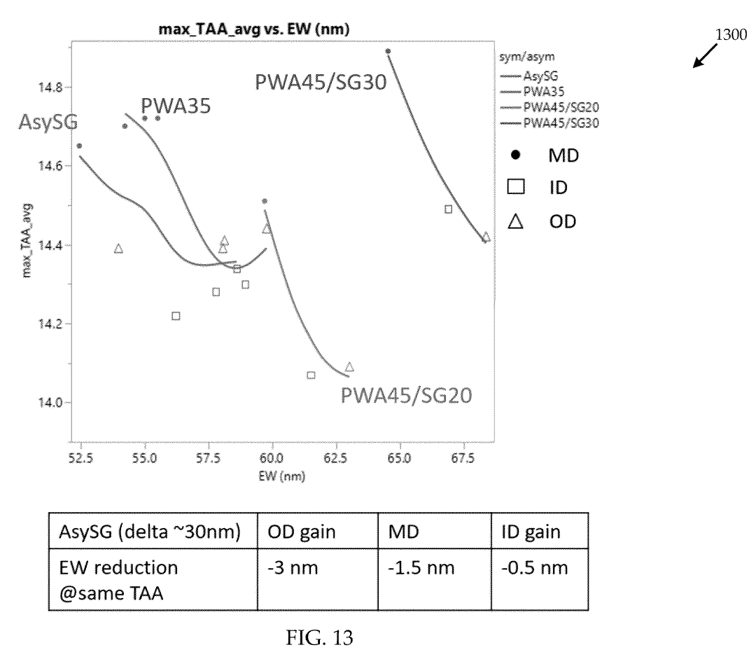

FIG. 13 illustrates an example graphical representation 1300 of a maximum TAA average relative to an EW for write head designs. As shown in FIG. 13, a wider PWA with a narrow SG (PWA45/SG20) could reduce the EW. However, the final maximum TAA signal may be downgraded than reference sample (PWA35/SG40) due to weaker writability. To overcome this issue, the asySG design (PWA35/SG20-60) can provide a reduction in EW but without penalty from maximum TAA signal as shown in FIG. 13. By extracting the EW reduction number from a different zone, it can be seen that there can be an advantage in CMR, which can mean a smaller EW with equivalent maximum TAA signal strength. Further, the table in FIG. 13 can show the EW gain in an asySG design.

The asymmetric design as described herein can be manufactured via an IBE or IBD process without using new masks. The designs can maintain a similar EW/FWHM without losing maximum TAA (signal track strength), while also benefitting a CMR writing mode. The EB can be improved on the narrow SG side, and an overall SMR ADC gain can be achieved if the best EB gain is assigned to the OD writing region. The device can be compatible with existing cTPP/TPP/GMAC/GMR3B designs.

In some instances, the asymmetric SG for a write head can include a magnetic main pole (MP) that provides a strong and concentrated field to write the magnetic media. The write head can also include a magnetic trailing shield (TS) which is composed of hot seed (HS) and write shield (WG) to collect flux from MP and increase down-track gradient.

The write head can also include two magnetic side shields (SS) to confine flux in cross-track direction to increase cross-track gradient. The SS or the MP can be shifted either left or right to create an asymmetric SG structure.

In some instances, the write head can include a magnetic leading edge taper (LET) to create taper in a leading side of the MP. The write head can include conductive materials in write gap (WG) and leading gap (LG) that allows current flow through, and insulation layers to guide and concentrate bias current.

The write head can be fabricated by ion beam etching (IBE) technique by applying directional etching strategy during the SS fabrication process. The write can also be fabricated by ion beam disposition (IBD) technique by directional deposition of either metal or insulation layer on top of SS. The etching or deposition materials can be either insulation materials, such as an aluminum oxide (AlOₓ), a silicone oxide (SiOₓ), an aluminum nitride (AlNₓ), or metals such as Ruthenium (Ru), a Nickel/Chromium (Ni/Cr) multilayer, or any materials with suitable thermal conductivity and electrical conductivity.

In some instances, the SG width can range from 5 nm to 100 nm on each side, and a difference between distances can range from 1 to 50 nm.

The write head can be shifted toward left or right side, as long as there is still a gap between the MP and SS and can be achieved by fabricating an asymmetric insulation layer or a metal layer.

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

It will be appreciated that the term “present invention” as used herein should not be construed to mean that only a single invention having a single essential element or group of elements is presented. Similarly, it will also be appreciated that the term “present invention” encompasses a number of separate innovations, which can each be considered separate inventions. Although the present invention has been described in detail with regards to the preferred embodiments and drawings thereof, it should be apparent to those skilled in the art that various adaptations and modifications of embodiments of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

1. A write head comprising:
a magnetic main pole (MP);
a magnetic trailing shield comprising at least a hot seed (HS) layer disposed adjacent to the MP; and
a first side shield (SS) portion disposed on a first side of a central axis and a second SS portion disposed on a second side of the central axis, wherein a center of the MP is disposed offset from the central axis such that a distance between a center of the MP and the first SS portion is less than a distance between the center of the MP and the second SS portion.

2. The write head of claim 1, wherein the HS layer is configured to collect a magnetic flux from the MP and increase a down-track gradient, and wherein the first SS portion and the second SS portion are configured to confine the magnetic flux in a cross-track direction to increase a cross-track gradient.

3. The write head of claim 1, further comprising:
a first dielectric layer disposed adjacent to the first SS portion;
a second dielectric layer disposed adjacent to the second SS portion;
a first metallic layer disposed between the MP and the first dielectric layer; and
a second metallic layer disposed between the MP and the second dielectric layer.

4. The write head of claim 3, wherein the second dielectric layer is milled to a thickness less than that of the first dielectric layer using an ion-beam etching (IBE) process by applying directional etching to the first dielectric layer and/or the second dielectric layer.

5. The write head of claim 4, wherein the directional etching is at an angle ranging from 0-20 degrees parallel to an air-bearing surface (ABS) direction, and at tilt angles ranging between 45-75 degrees perpendicular to the write head.

6. The write head of claim 3, wherein a thickness of the first metallic layer is greater than that of the second metallic layer based on an ion-beam disposition (IBD) process providing a directional deposition on the first metallic layer and/or the second metallic layer.

7. The write head of claim 6, wherein the directional deposition is at an angle ranging from 0-20 degrees parallel to an air-bearing surface (ABS) direction, and at tilt angles ranging between 10-30 degrees perpendicular to the write head.

8. The write head of claim 3, wherein the first dielectric layer and/or the second dielectric layer comprise an insulating material including aluminum oxide (AlOₓ), a silicone oxide (SiOₓ), an aluminum nitride (AlNₓ).

9. The write head of claim 3, wherein the first metallic layer and/or the second metallic layer comprise a Ruthenium (Ru) material or a Nickel/Chromium (Ni/Cr) multilayer.

10. The write head of claim 1, wherein a width of a side gap (SG) between each of the first SS portion and the second SS portion ranges between 5-100 nanometers (nm) on each side of the central axis.

11. The write head of claim 1, wherein a difference between the distance between the center of the MP and the first SS portion and the distance between the center of the MP and the second SS portion ranges between 1 and 50 nm.

12. A method comprising:
providing a write head structure with at least a first side shield (SS) portion disposed on a first side of a central axis and a second SS portion disposed on a second side of the central axis;
disposing a first dielectric layer adjacent to the first SS portion;
disposing a second dielectric layer adjacent to the second SS portion;
disposing a first metallic layer adjacent to the first dielectric layer;
disposing a second metallic layer adjacent to the second dielectric layer;
performing an ion-beam etching (IBE) process by applying directional etching to the first dielectric layer and/or the second dielectric layer to cause a different thickness between the first dielectric layer and the second dielectric layer, or performing an ion-beam disposition (IBD) process providing a directional deposition on the first metallic layer and/or the second metallic layer to cause a different thickness between the first metallic layer and the second metallic layer; and
disposing a main pole (MP) between the first SS portion and the second SS portion, wherein a center of the MP is disposed offset from the central axis such that a distance between a center of the MP and the first SS portion is less than a distance between the center of the MP and the second SS portion.

13. The method of claim 12, wherein the directional etching is at an angle ranging from 0-20 degrees parallel to an air-bearing surface (ABS) direction, and at tilt angles ranging between 45-75 degrees perpendicular to the write head.

14. The method of claim 12, wherein the directional deposition is at an angle ranging from 0-20 degrees parallel to an air-bearing surface (ABS) direction, and at tilt angles ranging between 10-30 degrees perpendicular to the write head.

15. The method of claim 12, wherein the first dielectric layer and/or the second dielectric layer comprise an insulating material including aluminum oxide (AlOx), a silicone oxide (SiOₓ), an aluminum nitride (AlNₓ).

16. The method of claim 12, wherein the first metallic layer and/or the second metallic layer comprise a Ruthenium (Ru) material or a Nickel/Chromium (Ni/Cr) multilayer.

17. A device comprising:
a magnetic main pole (MP);
a first metallic layer disposed adjacent to a first side of the MP;
a second metallic layer disposed adjacent to a second side of the MP;
a first dielectric layer disposed adjacent to the first metallic layer;
a second dielectric layer disposed adjacent to the second metallic layer;
a first side shield (SS) portion disposed on a first side of a central axis and adjacent to the first dielectric layer; and
a second SS portion disposed on a second side of the central axis, wherein a center of the MP is disposed offset from the central axis such that a distance between a center of the MP and the first SS portion is less than a distance between the center of the MP and the second SS portion.

18. The device of claim 17, wherein the second dielectric layer is milled to a thickness less than that of the first dielectric layer using an ion-beam etching (IBE) process by applying directional etching to the first dielectric layer and/or the second dielectric layer, wherein the directional etching is at an angle ranging from 0-20 degrees parallel to an air-bearing surface (ABS) direction, and at tilt angles ranging between 45-75 degrees perpendicular to the device.

19. The device of claim 17, wherein a thickness of the first metallic layer is greater than that of the second metallic layer based on an ion-beam disposition (IBD) process providing a directional deposition on the first metallic layer and/or the second metallic layer, wherein the directional deposition is at an angle ranging from 0-20 degrees parallel to an air-bearing surface (ABS) direction, and at tilt angles ranging between 10-30 degrees perpendicular to the device.

20. The device of claim 17, wherein the first dielectric layer and/or the second dielectric layer comprise an insulating material including aluminum oxide (AlOₓ), a silicone oxide (SiOₓ), an aluminum nitride (AlNₓ), and wherein the first metallic layer and/or the second metallic layer comprise a Ruthenium (Ru) material or a Nickel/Chromium (Ni/Cr) multilayer.
